(19) United States
(12) Patent Application Publication
(10) Pub. No.: US 2012/0015318 A1
(43) Pub. Date: Jan. 19, 2012

(54) METHOD FOR MATERIAL PROCESSING AND LASER PROCESSING DEVICE FOR MATERIAL PROCESSING

(75) Inventor: Anton KASENBACHER, Traunstein (DE)

(73) Assignees: Dr. Anton Kasenbacher, Traunstein (DE); Lumera Laser GmbH, Kaiserslautern (DE)

(21) Appl. No.: 13/185,835

(22) Filed: Jul. 19, 2011

Related U.S. Application Data
(63) Continuation of application No. PCT/DE2010/075005, filed on Jan. 18, 2010.

(30) Foreign Application Priority Data
Jan. 20, 2009 (DE) 10 2009 005 194.5

(51) Int. Cl. A61C 3/00

(52) U.S. Cl. 433/29

(57) ABSTRACT

A method for material processing and laser processing device for material processing. The laser machining device has a laser beam source to provide a pulsed processing laser beam, a laser beam aligning unit to output couple the laser beam in the direction toward a area of material to be machined, and an emission device to emit a photosensitizer in the direction toward a surrounding area of the area of the material to be machined, wherein the emission device is connected to the aligning unit.

### CROSS-REFERENCE TO RELATED APPLICATIONS

This application is a continuing application, filed under 35 U.S.C. §111(a), of International Application PCT/DE2010/075005, filed Jan. 18, 2010, it being further noted that priority is claimed and based upon German Patent Application 10 2009 005 194.5, filed on Jan. 20, 2009, the disclosures of which are incorporated herein by reference.

### FIELD

The present invention relates to a method for material processing and a laser processing device for material processing.

### BACKGROUND

The properties of laser radiation, more particularly the intensity and good focusability, have led to lasers these days being used in many fields of material processing. In laser processing methods, the laser beam is absorbed by the workpiece to be processed and the material of the workpiece is heated and molten or evaporates as a result of the high energy in the laser beam. By way of example, this allows holes to be drilled into metal plates or semiconductor wafers to be separated into individual semiconductor chips. The laser processing is generally undertaken by means of pulsed laser radiation in special laser processing devices. It is conventional for CO₂ or solid-state lasers, such as e.g. Nd:YAG, Nd:YVO₄ or Nd:GdVO₄ lasers, to be used as laser beam sources. An important feature of a laser processing method is the throughput, i.e. e.g. the number of holes that can be drilled into a metal plate within a unit time. This substantially depends on the efficiency of the removal or ablation procedure brought about by the laser beam. In addition to other aspects, there is a constant desire here to increase the efficiency and, as a result, either have a higher processing speed or a reduced energy input.

A further quality criterion of a laser processing device can be found in its applicability to different processing objects, more particularly its use for different materials to be processed. The situation may occur where different materials should be processed during a production process. By way of example, in the case of a printed circuit board (PCB), a conductor track consisting of metal and also the circuit board consisting of plastic and finally a semiconductor chip, consisting of silicon, applied to the circuit board should be processed, e.g. provided with through holes. A disadvantage of conventional laser processing devices consists of the fact that in general they can only perform one of these processing procedures. This is due to the fact that the processing procedures are dependent on a sufficiently large proportion of the laser radiation being absorbed by the material to be processed. However, conventional laser processing devices generally operate at a specific fixed wavelength, while the materials to be processed have their maximum or high absorption ability at different wavelengths.

When this application discusses material processing, this should, in principle, encompass all types of materials, i.e. more particularly materials in all states of matter, natural or synthetic type materials, and inorganic or organic materials. Biological tissues, such as devitalized or vital biological tissue, which also encompass hard tissue such as dental material, form a subset of these materials. Hence, the field of dentistry is an exemplary field of application for the present application, wherein a laser processing method and a corresponding laser processing device can be used in place of a mechanical drill for ablating or removing dental material, more particularly carious dental material. However, other types of biological tissue and tissue types, such as e.g. different types of hard tissue, soft tissue, and interstitial fluids, may likewise be affected. Accordingly, another potential field of application can for example be found in the field of ophthalmology.

A further important aspect of this application consists of ensuring maximum so-called biosafety when performing the processing methods described here, more particularly in the form of avoiding excessive ultraviolet radiation. In the case of laser processing of the type described in this application each laser pulse should interact with a thin surface region of the material such that plasma is formed in the focus of the processing laser beam. This plasma may be the cause of ultraviolet radiation, either as a result of recombination processes or in the form of Planck radiation as a result of the temperature of the plasma. It is well known that the ultraviolet radiation can have detrimental effects to the health. It goes without saying that this holds particularly true in the case of the aforementioned field of use in dentistry. Hence, it is a general goal to minimize the effects that are detrimental to health whilst maintaining the greatest possible ablation efficiency.

It is therefore an object of the present invention to specify a method for material processing, and a laser processing device for material processing, with the aid of which method and device it is possible to ensure efficient processing of a material, and furthermore to increase the versatility of use of a laser processing device, that is to say in particular the applicability for different materials. It is a further object of the present invention to specify a method for material processing, and a laser processing device for material processing, wherein method and device the ultraviolet radiation occurring during processing can be minimized.

These objects are achieved by the features of the independent patent claims. Advantageous developments and refinements are the subject matter of sub-claims.

### SUMMARY

A first insight of the present invention consists in that when ablating biological tissue with a laser beam it is not mandatory for the laser beam to be applied to the tissue itself. Instead of this, the laser beam can advantageously be absorbed by a substance that, as a consequence of the absorption acts essentially as a source of free or quasi-free electrons, and in such a way transmits the absorbed energy to the material to be removed. A so-called photosensitizer can be used most efficiently as such a substance. Photosensitizers constitute chemical photosensitive compounds that enter into a photochemical reaction after the absorption of a light quantum. The activation of a photosensitizer can be performed by laser light of suitable wavelength and adequate intensity, the absorption of light firstly exciting the photosensitizer in a relatively short-lived singlet state that thereafter crosses to a more stable (long-lived) triplet state. This excited state can then, for example, react directly with the material to be removed.

In accordance with a first aspect of the present invention, there is thus specified a method for material processing wherein a photosensitizer is brought into an area surrounding a region of the material that is to be processed, a pulsed processing laser beam is provided, and the region of the material that is to be processed is irradiated with the pulsed processing laser beam.

The processing laser beam can in this case emit laser pulses with a temporal full-width at half maximum in a broad range between 100 fs and 1 ns, this range also encompassing each incremental intermediate value, and the increment being 100 fs.

A further insight of the present invention consists, in a medical treatment method, in making use for a diagnosis, which is, if appropriate, to be carried out together with a processing method, of a marker that visualizes regions that are to be processed or to be ablated, the marker likewise possibly being a photosensitizer and/or being capable of excitation by radiation of a laser or a light-emitting diode (LED) continuously or in pulsed fashion, with a suitable wavelength, duration and intensity. It can in particular be provided to use one and the same photosensitizer for the ablation and also for the diagnosis.

A further insight of the present invention consists in surrounding a region of a material that is to be processed or ablated by means of a laser beam with a sheath, and integrating a suction channel system inside said sheath and a laser beam aligning unit connected therewith.

There are various possibilities with regard to the selection of the photosensitizer to be used and to the laser radiation source to be used for the ablation and/or the diagnosis. In accordance with the embodiments presented here, the photosensitizer and/or the wavelength of the laser pulses are/is selected in such a way that the laser beam is absorbed at least partially by a single photon absorption in the photosensitizer, the absorption being in the vicinity of an absorption maximum of the photosensitizer. This first embodiment is therefore to be assigned to linear optics. In accordance with a second embodiment, which is to be assigned to nonlinear optics, the photosensitizer and/or the wavelength of the laser pulses are/is selected in such a way that the laser beam is absorbed at least partially by a two photon absorption in the photosensitizer, the absorption being in the vicinity of an absorption maximum of the photosensitizer. In accordance with a third embodiment, which is likewise to be assigned to nonlinear optics, the photosensitizer and/or the wavelength of the laser pulses are/is selected in such a way that the laser beam is at least partially absorbed by a multi-photon absorption in the photosensitizer, the number of the absorbed photons being greater than 2, and the absorption being in the vicinity of an absorption maximum of the photosensitizer.

In accordance with one embodiment, a repetition rate of the laser pulses is set in a range between 1 Hz and 10 MHz, this range also encompassing each incremental intermediate value, and the increment being 1 Hz. In this case, it can also be provided that the laser pulses are generated in the form of bursts each having a prescribed number of laser pulses and that, for example, a prescribed number of bursts (for example, one burst) is applied to each site to be processed on the material to be ablated. The laser pulses can also have a pulse peak intensity varying in a prescribed way within a burst. Instead of a burst of a plurality of laser pulses, it can also be provided that an individual laser pulse is used, but it is preceded by a so-called ASE (amplified spontaneous emission) prepulse.

In accordance with one embodiment, the method is used for the ablation or removal of tooth material, in particular carious tooth material. This offers an advantageous field of application to the extent that carious tooth material is known to have a porous structure caused by bacterial attack. The photosensitizer can penetrate into this porous structure so that it is to some extent embedded in the carious tooth material to be removed, and need not—as required in other applications—be applied to a surface of a material to be removed.

During material processing with a short pulse laser such as a picosecond or femtosecond laser a microplasma is produced within a thin surface layer at the focus of the processing laser beam and decays after each individual pulse in the course of a time period in the nanosecond to microsecond range. During the ablation operation, the material is not ionized per interaction of the laser photons with the quasi-free electrons, but minimally fragmented invasively in a thermomechanical fashion. A general goal consists in always generating the microplasma in the threshold region, that is to say always less than or equal to the critical electron density (at laser wavelength 1064 nm: 1.03×10²¹ electrons/cm³). This renders it possible to carry out the ablation operation, in particular in the case of tooth or other tissue treatments, but as far as possible also in the case of other material processing methods, with the greatest possible medical and biological compatibility and the avoidance of undesired side effects. In particular, plasma temperatures of greater than or equal to 11,604.5 K (twice the temperature of the surface of the sun) accompanied by UV rays and multi-photon ionization are to be avoided, or to the maximum extent, in order thus to achieve the nonionization of water molecules present in the tissue. Furthermore, with regard to limiting the thermal and mechanical effects in the case of tooth treatments it is advantageous when the pulse length of the laser pulses is in a range of approximately 100 fs-100 ps, in particular at approximately 10 ps. The inventive combination of an indirect energy input by means of photosensitizers and the use of picosecond laser pulses then leads to maximum biological and medical compatibility of the treatment. Particularly with regard to stress relaxation, the picosecond laser pulses effect an optical penetration depth in such a way that no sort of shockwaves can propagate, and so the treatment can be carried out without pain.

In accordance with one embodiment, in the case of tooth or tissue treatments the energy density of the laser pulses is set in a range below 7.5 J/cm². In particular the energy of the laser pulses can be set in a range below 100 μJ, and the focus of the processing laser beam on a surface of the tissue and/or the photosensitizer can be set with a focal diameter in a range between 1 μm and 100 μm, it being possible to achieve the range of 1 μm to 5 μm by means of special optics. These measures ensure that the plasma density is always below the critical electron density. The inventive use of a photosensitizer moreover permits the use for the ablation of the biological tissue of an energy density of the laser pulses that is substantially below the above-named value, for example below 1.0 J/cm². This means that given appropriate energies of laser pulses it is possible to use conventional focal spot sizes, and there is no need for additional expenditure with regard to the focusing optics. However, it can also mean that given stronger focusing a laser radiation source with lower laser pulse energies can, if appropriate, be used, for example a laser radiation source that consists only of a laser oscillator without the use of a downstream optical amplifier. The expectable total costs of a laser processing device for carrying out the inventive method could thereby be reduced under some circumstances. Specifically, a commercial laser oscillator such as, for example, a solid state laser oscillator, in particular a picosecond laser oscillator, then suffices as laser radiation source. In order to be able to provide the most compact laser radiation source possible, it is, for example, also conceivable to use a laser diode or a multiple arrangement (array) of laser diodes, in particular as picosecond lasers.

In general, the use according to the invention of a photosensitizer means that, for the ablation of any material, an energy density of the laser pulses that is considerably below the energy density that would be necessary without the use of a photosensitizer, can be used.

In general, the processing laser beam is used to process a specific surface region of the material in order that, in accordance with a further embodiment, the laser beam is scanned in a suitable way over this surface region. In this context, it can prove to be advantageous in addition when the processing laser beam has a substantially rectangular (also called top hat) beam profile. It can then be provided in the scanning operation that exactly one laser pulse is applied to each subregion covered by the focus of the processing laser beam. This measure can also be provided independently of the presence of a top hat profile, for example, by stipulating that during the scanning operation, mutually adjacent sub regions, which are each covered by a laser pulse, have a mutual spatial overlap whose surface area is smaller than half or smaller than another fraction of the surface area of a subregion. Even given the presence of a Gaussian profile as “laser beam cross section”, it is possible in this way essentially for essentially only a single laser pulse to be applied to a subregion covered by the focus of the processing laser beam.

In accordance with a further embodiment, it can be provided that the spatial position of the focus is constantly controlled to be on the surface of the region during processing. As is elaborated further below in more detail, this can be performed by an autofocus unit in a wide variety of embodiments, where the closed-loop control to be carried out with optical means can be carried out without glare by using a fixing element which serves as glare protection.

In accordance with a further embodiment provided for tissue treatments, it can be provided that before application of the photosensitizer, the region to be processed is determined by applying to the tissue a marker that assumes a characteristic coloration in contact with a specific tissue type, in particular damaged tissue, or that exhibits another detectable response, for example after excitation by coherent or incoherent electromagnetic radiation. In this case, the marker can likewise be supplied by a photosensitizer that thus constitutes a diagnostic photosensitizer, while the photosensitizer used for the ablation can be denoted as an ablation photosensitizer. The marker can, however, likewise be formed by another commercial marker which has no photosensitizer properties. In contrast, by way of example, the ablation photosensitizer can be such that it has no marker properties, that is to say acts in a non-staining fashion upon contact with various tissue types.

In accordance with a further embodiment, it is also possible to use a photosensitizer that is firstly used as a marker and subsequently is used for the ablation. This could simplify the treatment in that it is only those regions of the deposited photosensitizer that exhibit a color change, or exhibit another type of corresponding reaction during diagnosis, that are irradiated with the laser for the subsequent ablation. In other words, a photosensitizer that is identical to the photosensitizer used for the later ablation is used for the diagnosis. The diagnosis is then based, for example, on the same absorption properties of the photosensitizer as the later ablation.

In accordance with a further embodiment, the marker or photosensitizer used for the diagnosis and which is intended to mark or indicate damaged tissue can have additional properties. It can, for example, act as an acid (pH) indicator and/or as a bacteria and/or virus and/or tumor cell indicator, that is to say is able to indicate, by a specific response such as a color change or fluorescence radiation, the height of a pH value of an adjacent tissue, or the extent to which the tissue is infected with bacteria and/or viruses and/or tumor cells. The photosensitizer can also be designed so that it can act as a so-called 3D indicator, that is to say it is able to reflect or retroreflect the light pulses in such a way that they can be imaged on a detector, and a three-dimensional topography of the surface covered by the photosensitizer can be determined by determining the transit time of the light pulses emitted and retroreflected by a specific point. This can be used to particular advantage in a situation wherein it has previously been established by means of one and the same photosensitizer that damaged tissue is no longer present, and therefore there is no need for further ablation operations. A cavity produced by the previous ablation operations, for example, a tooth cavity, is subsequently to be filled in a way known per se with a material for which the shape of the cavity has to be determined. Conventional and in part very expensive methods of dentistry can be replaced when use is made of a photosensitizer covering the cavity surface and it is scanned with the diagnostic radiation so that the topography of the cavity can be determined via the received light pulses and the transit times. It may be pointed out that there is to be seen in such a method an independent invention that can be applied independently of the aspects chiefly described here, but which can optionally be combined at the discretion of the person skilled in the art with all the aspects and features described in this application.

In accordance with a further embodiment, it can be provided that the region to be processed is determined during diagnosis in a tooth treatment without the use of a marker or photosensitizer, specifically by determining the presence of a signal generated in the tissue and, if appropriate, the signal strength thereof. In this case, the signal can be the second or a higher harmonic of an electromagnetic radiation irradiated onto the tissue. The electromagnetic radiation can be that of a diagnostic laser beam that has an energy density on the surface of the tissue that is smaller than the energy density that is required for processing the tissue. The processing laser beam and the diagnostic laser beam can be produced by one and the same laser radiation source. Particularly for the purpose of distinguishing between undamaged tooth material and carious tooth material, the tissue can be excited by the diagnostic laser beam by means of the LIBS (Laser Induced Breakdown Spectroscopy) method in the infrared region, a backscattered signal of a second harmonic indicating a healthy tissue (for example, mineralizable collagen fibers), and the absence of such a signal indicating a carious tooth material (that is to say irreversibly damaged=non-mineralizable collagen structures). A region of the tissue can be scanned with the diagnostic laser beam, and the data of the backscattered second harmonic can be detected and stored, and it is then possible to use these data to determine wherein sections of the region the processing or ablation is to be performed by the processing laser beam.

According to another embodiment, provision can be made in the case of a medical treatment for a processing method to be carried out in a computer controlled fashion and provision can more particularly be made in the process for online control of the laser parameters as a function of the measured UV radiation. By way of example, the dermatological UV index can be used as decisive threshold criterion in this case, i.e. an increase above a specific predetermined UV index threshold automatically results in a reduction in the laser power until the UV index has once again fallen below the threshold. Additionally, provision can also be made for the laser beam to be interrupted, either briefly or permanently, as a preventative measure if other events or conspicuous features occur. By way of example, this may be envisaged if the therapy duration has exceeded an envisaged maximum time, if it is determined that too many pulses were emitted to a single location, if laser instabilities were determined or if other defects occurred in the apparatus.

According to a further embodiment, provision can also be made in the case of (non-medical) workpiece processing for a diagnosis to be carried out before carrying out the actual processing, i.e. applying the processing laser beam to the region to be processed, for example a diagnosis such that the type of material of a region of a workpiece is determined and the processing laser beam is subsequently switched on or not switched on. By way of example, use can also be made in this case of a diagnostic laser beam, which can be directed on the region of the workpiece, wherein the diagnostic laser beam originates from one and the same laser beam source as the processing laser beam but has a mean intensity that does not allow processing or ablation. Radiation returned from the workpiece, e.g. reflected radiation, fluorescence radiation, thermal radiation, higher harmonics, or the like can then be detected and evaluated, and the material type can be established from the evaluation.

According to a second aspect of the present invention, a method for material processing is specified, wherein a pulsed laser beam is provided in a processing mode, a region to be processed of the material is irradiated by the pulsed processing laser beam, electromagnetic radiation emitted from surroundings of the processed region is detected, and the pulsed laser beam is set depending on the detected electromagnetic radiation.

According to one embodiment, the electromagnetic radiation can be ultraviolet radiation because this spectral range has the greatest relevance with respect to biological tolerance. However, it is also possible to detect electromagnetic radiation in another spectral range, for example in the infrared wavelength range because there may also be adverse health effects if certain dose thresholds of IR-A and IR-B radiation are exceeded. Since this in general always depends on the dose, this also holds true for further wavelength ranges of the electromagnetic spectrum.

According to one embodiment, the electromagnetic radiation can be detected by at least one appropriate detector. Accordingly, one or more UV detectors should be provided in the case of UV radiation. In the process, a plurality of UV detectors can be used to determine the intensity and also the wavelength and UV index of the detected UV radiation.

According to a further embodiment, the processing procedure can be controlled online by modifying at least one parameter of the processing laser beam if evaluating the signal supplied by the at least one UV diode yields that the detected UV radiation is too high as per prescribed criteria or exceeds certain thresholds. By way of example, the parameter of the processing laser beam to be modified may be the pulse peak intensity, the pulse duration, the repetition frequency, the number of pulses within a burst, or else another suitable parameter, or a plurality of the aforementioned parameters. The at least one parameter is modified until the signal of the at least one UV detector indicates that the detected UV radiation once again lies in an acceptable range.

According to a third aspect of the present invention, a method for material processing is specified, wherein a pulsed laser beam is provided in a processing mode, a region to be processed of the material is irradiated by the pulsed processing laser beam, and the pulsed laser beam is set such that at least one of the following conditions is met: the temperature of plasma generated by the processing laser beam is no more than 11604.5 K, which corresponds to 1 eV, the mean oscillation energy of the electrons in the alternating electromagnetic field of the processing laser beam is below 0.021 eV.

Such a method as per the third aspect can be combined with the above-described methods as per the first and the second aspect. When combined with a method as per the second aspect, provision can for example be made for a calculation to be carried out before starting the processing method, the goal of said calculation being to establish suitable parameters of the processing laser beam using the relevant parameters of the material to be processed, which processing laser beam parameters can achieve or are expected to achieve the aforementioned conditions in respect of the plasma temperature and the mean oscillation energy. During the running processing operation, the electromagnetic radiation, e.g. the UV radiation, is established as per the second aspect and the processing laser beam is continuously readjusted as a function thereof, and so the detected electromagnetic radiation does not exceed certain prescribed thresholds.

In accordance with a further aspect of the present invention, a laser processing device is specified for material processing according to the method according to the first aspect, the laser processing device having a laser radiation source for providing a pulsed processing laser beam, a laser beam aligning unit for decoupling the laser beam in the direction of a region of the material to be processed, and an output device for outputting a photosensitizer in the direction of an area surrounding the region of the material to be processed, the output device particularly being connected to the laser beam aligning unit.

In accordance with one embodiment of the laser processing device, it can be provided that the laser radiation source is provided by a laser oscillator whose output pulses can be fed to the aligning unit without further amplification so that—as already set forth above—the laser radiation source can be designed cost-effectively. It can prove to be necessary, in this case, to focus the laser beam more intensely so as to be able to reach the required energy densities. However it is also possible to use a laser radiation source consisting of a laser oscillator and an optical amplifier of the laser pulses, wherein case conventional focusing can prove adequate.

In accordance with one embodiment of the laser processing device, the wavelength of the laser pulses and the photosensitizer are selected in such a way that the processing laser beam is absorbed at least partially by a single photon absorption in the photosensitizer, the absorption being in the vicinity of an absorption maximum of the photosensitizer.

In accordance with one embodiment of the laser processing device, the wavelength of the laser pulses and the photosensitizer are selected in such a way that the processing laser beam is absorbed at least partially in the photosensitizer by an N photon absorption, with N≧2, the absorption being in the vicinity of an absorption maximum of the photosensitizer.

In accordance with one embodiment, the laser pulses have a full-width at half maximum in a range between 100 fs and 1 ns, this range also encompassing each incremental intermediate value and the increment being 100 fs.

In accordance with one embodiment, the wavelength of the laser pulses lies in a range between 100 nm and 10.6 μm, this range also encompassing every incremental intermediate value, and the increment being 10 nm. This range therefore also encompasses, for example, the output wavelengths of Er:YSGG (λ=2.7 μm) or Er:YAG lasers (λ=2.94 μm) whose wavelengths lie in the infrared wavelength region, or a CO₂ laser, whose output wavelength lies at 10.6 μm. All wavelengths in the specified range are conceivable when combined with suitable existing photosensitizers, or ones yet to be developed.

In accordance with one embodiment, the energy density of the laser pulses on the surface of the tissue and/or the photosensitizer to be processed lies in a range below 7.5 J/cm². Depending on the selection of the photosensitizer, an energy density of 1.0 J/cm² or else therebelow can be adequate for the ablation.

In accordance with one embodiment, the energy of the laser pulses lies in a range below 100 μJ, in particular a focus of the processing laser beam on a surface of the tissue being set to a focal diameter in a range between 1 μm and 100 μm. The range of 1 μm to 5 μm can be achieved with the aid of special optics.

In accordance with one embodiment, a repetition rate of the laser pulses is set in a range between 1 Hz and 10 MHz.

In accordance with one embodiment, the laser processing device is designed as a dental laser processing device for the ablation or removal of tooth material, in particular carious tooth material.

In accordance with one embodiment, the laser processing device further comprises a fixing means connected to the laser beam aligning unit for spatially fixing a distal end of the laser beam aligning unit with reference to a section of the material to be processed.

In accordance with one embodiment, the laser handpiece comprises an attachment that serves not only as fixing means but also sheaths the region to be processed in such a way that it is possible if appropriate together with an integrated suction channel system to supply various process gases, to generate various chemical compositions and/or various pressure conditions. In the case of a tissue or tooth treatment, for example mercury, for example in the form of an amalgam filling, can thus be ablated and suctioned away.

In accordance with one embodiment, the laser processing device further comprises a beam shaping unit for shaping a substantially rectangular beam profile of the pulsed processing laser beam.

In accordance with one embodiment, the laser processing device further comprises a scanning unit for scanning a region of the material with the processing laser beam or if appropriate the diagnostic laser beam. In this case, the scanning unit can, in particular, be designed in such a way that exactly one laser pulse is applied to a subregion covered by the focus of the processing laser beam. For example, the scanning unit can be designed in such a way that mutually adjacent sub regions covered by one laser pulse in each case have a spatial overlap with one another whose surface area is smaller than half a subregion.

In accordance with one embodiment, the laser processing device further comprises an autofocus unit for keeping constant the spatial position of the focus on the surface of the material.

In accordance with one embodiment, the laser processing device further comprises a detection unit for detecting the presence of a signal generated in the material or in an area surrounding it, and the strength of said signal, if appropriate. The detection unit can have an optical sensor that is, for example, designed to detect a second or higher harmonic of an electromagnetic radiation irradiated onto the material. The electromagnetic radiation can be that of a diagnostic laser beam which is produced by one and the same laser radiation source like the processing laser beam, or it can be that of an incoherent and, in particular, continuously emitting light source such as a light-emitting diode (LED).

In accordance with one embodiment, the laser processing device can have a control unit that is designed for the purpose of setting the laser radiation source to a processing mode or a diagnostic mode, the pulsed processing laser beam being produced in the processing mode, and there being produced in the diagnostic mode a diagnostic laser beam that has an energy density on the surface of the material which is smaller than the energy density that is required for processing the material. In principle, this can be the same laser beam as the processing laser beam whose energy has merely been changed by the control unit in such a way that the energy density is smaller than the energy density required for the processing. If appropriate, instead of or in addition to the energy it is also possible to change the focusing so that a lower energy density results. In this case, it is the object of the diagnosis mode to determine which material is involved.

In accordance with one embodiment, the laser beam aligning unit can be provided in the form of a handpiece, it being possible to arrange the output device for outputting the photosensitizer at least partly inside the handpiece, in particular one end of a supply line with a nozzle possibly being arranged in the handpiece. The scanning unit and/or the autofocus unit can also be arranged inside the handpiece.

In accordance with one embodiment, the laser processing device further comprises a further output device for outputting a marker, it being possible, in particular, likewise to arrange the further output device partly inside the handpiece.

According to one embodiment, the laser pulses have a full-width at half maximum in a range between 100 fs and 1 ns, this range also encompassing each incremental intermediate value and the increment being 100 fs.

According to a further aspect of the present invention, a laser processing device for material processing according to the method as per the second aspect is specified, wherein the laser processing device has a laser beam source for providing a pulsed processing laser beam, a laser beam alignment unit for decoupling the laser beam in the direction of a region to be processed of the material, and a UV photodetector for detecting ultraviolet radiation emitted from surroundings of the processed region.

Further embodiments can be provided by applying features that have been described further above in conjunction with the first aspect of this invention to the further aspect of relevance here.

### BRIEF DESCRIPTION OF THE DRAWINGS

The invention is explained in more detail below in the form of further embodiments and with the aid of the drawings, wherein:

FIG. 1 is a schematic of an embodiment of a laser processing device;

FIG. 2 is a schematic of a further embodiment of a laser processing device;

FIG. 3 is a schematic of an embodiment of a laser beam aligning unit; FIG. 4 is a schematic of an embodiment of a laser beam aligning unit;

FIG. 5 is a schematic of an embodiment of a laser beam aligning unit;

FIG. 6 is a schematic of an embodiment of a laser beam aligning unit; and

FIGS. 7A and 7B are schematics of an embodiment of a laser beam aligning unit in a side view (A) of FIG. 7A and a partial cross-sectional view (B) of FIG. 7B.

### DESCRIPTION OF EMBODIMENTS

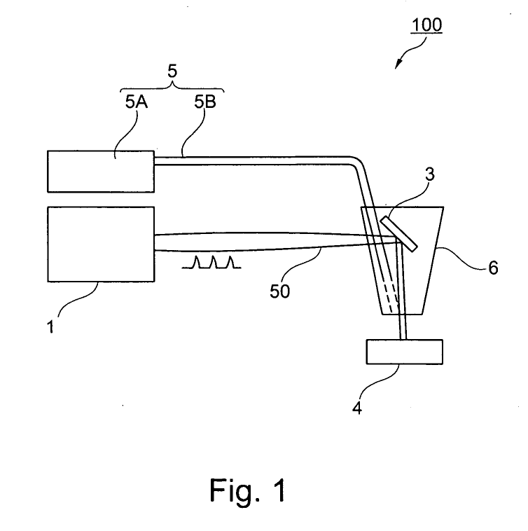

FIG. 1 is a schematic of a general embodiment of a laser processing device according to the first aspect, which is not illustrated with dimensional ratios true to scale. The laser processing device 100 has a laser radiation source 1 that emits a pulsed processing laser beam 50. The processing laser beam 50 is focused onto a workpiece 4 that is to be processed. If appropriate, the processing laser beam can be deflected beforehand by an optical deflection unit 3 such as a mirror, a mirror system composed of a plurality of mirrors, a scanning device or a deflection prism. The workpiece 4 can consist of any desired material, as mentioned in the introduction. It can in this case also be a tooth of a patient or another biological tissue.

It can be provided in this case that the laser radiation source 1 produces the laser pulses in such a way that the latter have a pulse duration in a range between 100 fs and 1 ns and an energy per pulse in a range below 100 μJ. The focusing of the laser beam can be set in such a way that the processing laser beam 50 on the surface of the workpiece 4 has a focus with a focal diameter in a range from 1 μm to 100 μm.

It can further be provided that the laser radiation source 1 emits the laser pulses with a repetition rate in a range from 1 Hz to 10 MHz.

The laser processing device 100 further has an output device 5 for outputting a photosensitizer in the direction of an area surrounding the region of the workpiece 4 that is to be processed. As illustrated, the output device 5 can include a storage chamber 5A for storing the photosensitizer, and a supply line 5B connected thereto. Use may be made as photosensitizer of, for example, erythrosin, which can be efficiently excited by two photon absorption of the laser radiation of an Nd:YAG laser (1064 nm) or by single photon absorption of the frequency doubled component of the Nd:YAG laser (532 nm). Methylene blue, Photofrin and organometallic dendrimers may be mentioned here, by way of example, as further photosensitizers. Also included herewith are all further photosensitizers to be gathered from the relevant specialist literature as well as photosensitizers still to be developed in future, there always being the need to tune the absorption maximum of the photosensitizer to the laser wavelength, or at least to an area surrounding it. Biochemical chromophores can also be photosensitizers in the sense understood here. The term photosensitizer is intended by definition also to cover substances that are not photosensitizers in the technical sense, but which are able, under defined physical and chemical conditions, to assume the properties typical of photosensitizers. Included amongst these in principle are, for example, any gases or gas mixtures (air) or aerosols, the starting point requiring to be the fact that all these substances exhibit photosensitizer properties only within defined physical and chemical properties. In accordance with the definition reproduced above, it is also possible to use a photosensitizer that bears a negative charge when applied to a substrate, that is to say already acts in the non-excited state as a free charge carrier or includes free charge carriers that can then make an additional contribution during the later ablation to the free charge carriers produced by absorption. In accordance with the definition reproduced above, it is also possible to make use of such a photosensitizer, which is applied as a cluster of small ions such as, for example, air ions. Such a photosensitizer also already has in the initial state, that is to say the non-excited state, free charge carriers that can develop supportive action in the later ablation process.

The laser processing device 100 further has a laser beam aligning unit 6 for aligning the laser beam 50 in the direction of a region of the workpiece 4 that is to be processed. In the exemplary embodiment shown, the aligning unit 6 includes the deflection unit 3 and is, moreover, connected to the supply line 5B of the output device 5 so that the photosensitizer emerges from the supply line 5B at the distal end of the aligning unit 6, and can be applied in the desired way to the desired region of the workpiece 4.

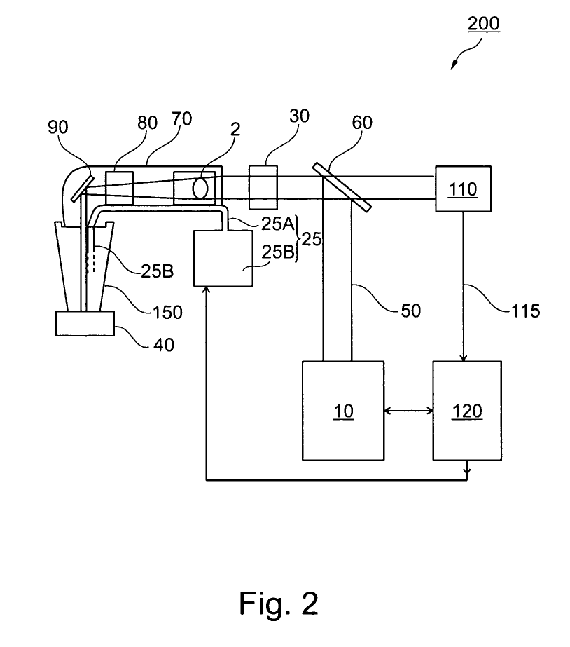

FIG. 2 is a schematic of a further embodiment of a laser processing device that is illustrated with dimensional ratios not true to scale. The embodiment of a laser processing device 200 shown in FIG. 2 comprises a laser radiation source 10 that emits a pulsed processing laser beam 50. In the exemplary embodiment shown, the laser radiation source 10 is an Nd:YAG laser that is coupled to a transient or a regenerative amplifier and emits laser pulses at a wavelength of 1064 nm. It is also possible to make use here of another laser radiation source such as, for example, an Nd:YVO₄ or an Nd:GdVO₄ laser or a laser that includes another Nd doped laser crystal. In the same way, a short-pulsed Yb-doped laser such as, for example, a Yb:YAG or Yb:KYW laser can be used. The pulse duration of the laser pulses is 10 μs, and the repetition rate of the laser pulses lies in a range between 1 Hz and 10 MHz. The energy of the laser pulses is 40 μJ. Given a repetition rate of 100 kHz, the mean radiant power is 4 W.

It is also possible in principle to make use of any other laser as laser radiation source. By way of example, in principle the laser radiation source can also be provided by a diode laser or a diode laser array that can, if appropriate, be accommodated in the handpiece in a particularly compact way. In particular, the output pulses of the laser radiation source can be used without further optical amplification, that is to say they can be fed to the handpiece or the aligning unit.

In the case of the embodiment shown in FIG. 2, in its profile the processing laser beam 50 emitted by the laser radiation source 10 strikes an optical deflection unit 60 that, however, acts as a deflection unit only for the wavelength of the processing laser beam 50 and so the processing laser beam 50 is deflected by approximately 90°.

Located subsequently in the beam path of the processing laser beam 50 is a beam shaping unit 30 with the aid of which a rectangular or top hat beam profile is produced.

Subsequently, the processing laser beam 50 enters a laser beam aligning unit 70 designed as a handpiece. In its input-side section, the aligning unit 70 includes a lens 2 that is part of an autofocus unit 20. The autofocus unit 20 employs means known per se to the effect that the focus produced by the lens 2 always lies in the plane of the processed surface of the workpiece 40. In particular, the autofocus unit 20 can interact with an optical sensor device that evaluates a radiation retroreflected by the surface of the workpiece 40 to determine whether the surface still lies at the focus of the laser radiation. Thereupon, a control signal is transmitted to the autofocus unit 20 in order to take a suitable measure so that the surface of the workpiece 40 moves into the focus of the laser beam again. This measure can, for example, consist in a movement of the lens 2 forward or backward along the path of propagation of the laser beam 50. This can be ensured by a fast stepper motor that is connected to a carriage on which the lens 2 is mounted. However, it can also be provided that the lens 2 is designed in such a way that its refractive power can be varied.

In accordance with the embodiment of FIG. 2, the lens 2 is arranged in such a way that it produces a focus with a focal diameter of 40 μm on the surface of the workpiece 40. In the case of a tooth treatment, together with the value named further above for the pulse energy of a laser pulse, this therefore advantageously yields an energy density of 3.18 J/cm², leading in turn to a pulse peak intensity of 3.18·10¹¹ W/cm². This corresponds to a photon flux density of 1.18×10³⁰ photons·cm⁻²·s⁻¹. The electrical field strength of the alternating electromagnetic field is 1.55·10⁷ V/cm and the mean oscillation energy of the electrons in the alternating electromagnetic field is 0.021 eV. This is two orders of magnitude below typical chemical binding energies, that is to say the laser field is not strong enough to compete directly with atomic binding forces.

It may be remarked that the beam shaping unit 30 can also be located in the beam path downstream of the lens 2, that is to say can also particularly be located in the handpiece 70. It can also be provided that the autofocus unit 20 and the beam shaping unit 30, in particular the lens 2 and the beam shaping unit 30, are combined to form a common optical component.

Arranged in a further section of the aligning unit 70 is a scanning unit 80 with the aid of which the processing laser beam 50 or a diagnostic laser beam can be scanned, likewise in a way known per se—for example by means of two oppositely situated vibrating or oscillating mirrors—over a specific region of the surface of the workpiece 40 that is to be processed. The processing laser beam 50 or a diagnostic laser beam is then deflected in the direction of the workpiece 40 by means of a further deflection unit 90 such as, for example, a deflection prism or a reflecting mirror.

In this embodiment, the scanning unit 80 is therefore arranged in the handpiece. However, it is also possible to conceive other embodiments, wherein the scanning unit is arranged in the beam path upstream of the handpiece, that is to say, in particular, within an articulated mirror arm or at the input of an articulated mirror arm of the optical device upstream of the handpiece.

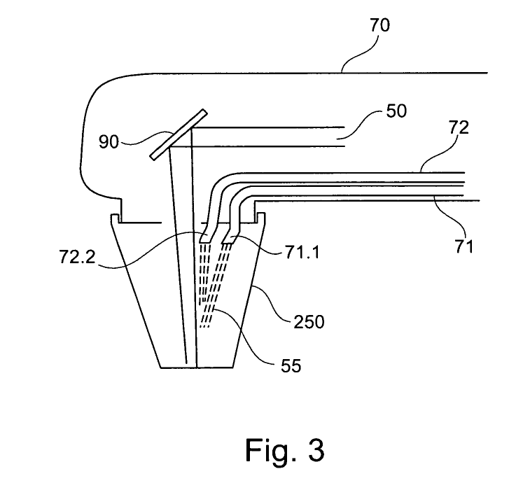

The aligning unit 70 designed as a handpiece can be held either manually or by a robot during processing and be directed onto the workpiece 40 to be processed. In order to facilitate this type of manipulation and, in particular, to keep the position and alignment of the distal end of the aligning unit 70 constant with reference to the workpiece 40 to be processed, a funnel-shaped attachment 150 is fastened on the distal end of the aligning unit 70. The attachment can have the function of a fixing element and can be suitably fixed on the workpiece 40 during the processing, as is explained in yet more detail in conjunction with the embodiments of FIG. 3 to FIG. 7. This type of fixing is preferably provided in the case of a medical treatment when the workpiece 40 is thus, for example, a tooth of a patient. In this case, prior to applying the fixing, the treating doctor can additionally also place a rubber dam or stretch rubber beforehand around the tooth so as to separate the latter from the remainder of the oral cavity.

A fixing element 150 can also be provided in the case of (non-medical) processing of a workpiece 40. Said fixing element may for example serve to supply the workpiece region to be processed with specific process gases in addition to the photosensitizer, to set a desired atmosphere or to suction away ablated material.

The attachment or the fixing element 150 can also have the additional features or properties individually or in combination. It can serve as an effective glare protection because work is always undertaken in the vicinity of the plasma threshold during processing and this generally goes hand-in-hand with the production of strong light, which can adversely affect the operator during the operation. It can furthermore serve as a UV-beam reflector if the interior wall thereof has an appropriate design such that UV-light generated in the plasma can be efficiently routed to a UV detector. It can furthermore be embodied such that it acts as an absorber of free electrons and/or ions and/or radicals in order to contribute to the highest levels of biosafety in this respect as well. It can furthermore be manufactured from a flexible and adaptable material such as e.g. silicone so that it provides the best-suited flexibility for fixing it to any basis. It can furthermore have a double-walled embodiment, wherein channels are arranged in the intermediate space for suctioning away ablated material (laser smoke) or for generating a vacuum in the fixed state. This can take the form of the outer wall being flat and planar and the inner wall having a suitable perforation for forming the channels.

The laser processing device 200 further has an output device 25 for outputting a photosensitizer in the direction of an area around the region of the workpiece 40 to be processed. The output device 25 includes a storage chamber 25A and a supply hose 25B, that is connected thereto and opens into the aligning unit 70 and is guided as far as into the fixing element 150 inside the aligning unit 70.

The optical or acoustic signals generated in the processed region of the surface of the workpiece 40 or in an area surrounding the latter can be detected and used for diagnostic aims. It has already been explained with reference to optical signals that the latter are based, for example in the case of a tooth treatment, in particular in the case of a caries diagnosis, on the second (SHG, second harmonic generation) or on a higher harmonic of electromagnetic radiation that acts on the tooth material provided for being processed. The exemplary embodiment shown in FIG. 2 is intended to be explained below with the aid of the case of the detection of an SHG signal.

For this type of diagnosis, there is set in the laser radiation source 10 a diagnostic mode wherein there is emitted a diagnostic laser beam whose energy or energy density lies below the ablation or plasma production threshold so that no processing can take place with this laser beam. It is intended for the diagnostic laser beam, which is also pulsed like the processing laser beam, to be used to investigate whether a surface region of the tooth that is to be processed contains healthy or carious tooth material. Healthy tooth material supplies a higher SHG signal than does carious material. The frequency doubled radiation produced in such a way at the tooth surface traverses at least partly in the reverse direction the beam path of the processing laser beam as has been described above, and is thus deflected by the deflection unit 90, traverses the scanning unit 80 and the autofocus unit 20 with the lens 2, and finally strikes the beam splitter 60 which is, however, transparent to the wavelength of the SHG signal so that the frequency doubled radiation can be fed to an optical detection device 110. The optical detection device 110 can be provided as a simple photodetector with which the intensity of the SHG radiation is measured. It can also be provided with use as optical detection device 110 of a more complex system such as a spectrometer, a CCD camera or a CMOS image sensor. Such optical detection devices can, for example, simultaneously serve the purpose of cooperating in a suitable way with the autofocus unit 20, as already indicated above.

Likewise, the deflection unit 90 can be designed so that it transmits the frequency doubled radiation produced at the tooth surface, and leads said radiation to the optical detection device 110, for example, with the aid of a glass fiber that is located downstream of the deflection unit 90. This reduces the outlay on the optical beam path for guidance of the frequency doubled radiation, since the optics 80, 20, 60, 2 need not be designed for a plurality of wavelengths, nor, possibly, coated. An optics that focuses the frequency doubled light onto the glass fiber can be inserted between the deflection unit 90 and the glass fiber for the purpose of coupling in the frequency doubled light more efficiently. The optics can be designed in the form of a microoptics.

The values, determined by the optical detection device 110, for the SHG radiation are converted into a signal 115 and fed to a combined evaluation and control unit 120, it also being possible in this embodiment for the evaluation and control unit 120 to be a computer system. However, all other control and regulating systems are also possible in principle, such examples being PLC(s) (programmable logic controllers), microcontrollers or analogous control loops.

The laser radiation source 10 can feed the evaluation and control unit 120 a signal that includes data relating to the operating state of the laser radiation source 10. As a function of the signal 115 transmitted by the optical detection device 110, the evaluation and control unit 120 outputs a control signal that is fed to the laser radiation source 10 and, for example, switches the laser radiation source 10 from a standby mode into an operating mode.

The embodiment shown in FIG. 2 comprises, in particular, a laser radiation source 10 that can switch over between the operating modes of “out” (standby mode), “diagnostics” and “therapy” (processing). In this embodiment, the laser radiation source 10 emits both the processing laser beam during the “therapy” mode and, under changed conditions, the diagnostic laser beam during the “diagnostics” mode. The difference between the diagnostics mode and the therapy mode is essentially the pulse peak intensity in W/cm², which is applied to the tooth surface. In the diagnosis mode, the energy density must be reliably below the ablation threshold, whereas it lies above that in the therapy mode.

In the diagnosis mode described above, it is possible, for example, to scan a specific surface region of the tooth 40 with the diagnostic laser beam, and the backscattered SHG signal can be received and evaluated. The surface region can be mapped to a certain extent on this basis, a surface section that is to be processed or to be ablated being identified. After the diagnosis mode has been carried out, the evaluation and control unit 120 gives a signal to the output device 25, whereupon the output device 25 applies the photosensitizer to the region of the tooth surface to be ablated, doing so by means of the supply channel 25B and the controllable nozzle mounted on the end thereof.

A diagnosis can be carried out in a similar fashion in the case of (non-medical) workpiece processing by receiving and evaluating a backscattered signal, caused by a diagnostic laser beam. In addition to an SHG signal, this backscattered signal may also be a reflected signal, a fluorescence signal, or a thermal signal. However, as an alternative to this, there may also be a purely light-optical examination of a workpiece surface and a decision can be made, optionally with the aid of image recognition methods, whether or not a specific surface region of the workpiece should be processed by the processing laser beam.

An aligning unit 70 in the form of a handpiece is represented in FIG. 3 in a cross section in order to illustrate a further exemplary embodiment for a diagnosis. In this exemplary embodiment, the distinction between material not to be processed and material to be processed is made not with the aid of an optical signal such as an SHG signal but with the aid of a marker that assumes a characteristic coloring when in contact with the material to be processed. This marker can be fed to the workpiece by a further supply line 72, which likewise runs inside the handpiece. After it has been established in such a way—preferably by an optical recording and subsequent image evaluation—which regions of a workpiece surface are to be processed, the photosensitizer, which is fed to the workpiece via the supply line 71, is applied to these regions, which can subsequently be processed or ablated by the processing laser beam 50. Consequently, there is no need in this embodiment for a diagnostic laser beam, nor the ability to switch over the laser radiation source, nor likewise any detection of an optical signal such as of an SHG signal. It is possible to connect to the two supply lines 71 and 72 nozzles 71.1 and 72.1 that can be controlled and aligned and with the aid of which the materials can be applied by aiming them onto the workpiece surface. In the case of a tooth treatment, the marker can be used for example to make a visible distinction between healthy tooth material (not to be processed) and carious tooth material (to be processed).

It may be remarked that the embodiment illustrated in FIG. 3 of a laser beam aligning unit can be regarded as an independent invention. This laser beam aligning unit has a handpiece 70, a deflection unit 90 for deflecting a processing laser beam 50 and/or, if appropriate, a diagnostic laser beam, and an attachment 250 for fixing the handpiece 70 on a surrounding area of the material to be processed, the handpiece 70 being designed so that it is possible by means of a supply line 71 running in the interior of said handpiece to apply a photosensitizer and, if appropriate, by means of a further supply line 72 to apply a marker to a workpiece region that is to be processed or to be diagnosed. This independent invention can also be combined with any of the other embodiments described in this application, and/or be developed with any of the features described in this application. This also covers primary units such as a laser processing device that, as described above, includes a laser beam aligning unit.

An aligning unit 70 in the form of a handpiece is represented in FIG. 4 in a cross section in order to illustrate a further exemplary embodiment. At least one laser or light-emitting diode (LED) 73 is arranged in the interior of the handpiece 70 in the case of this exemplary embodiment. It is also possible, as shown in FIG. 4, for a plurality of LEDs 73 to be present. In the state wherein the attachment 250 is not yet fixed, these LEDs 73 can be used to illuminate the workpiece and in particular can enable thereby the attachment 250 to be positioned in optimum fashion relative to the surface region of the workpiece 40 to be treated. They can, moreover, serve the purpose of exciting a marker applied to the surface of the workpiece 40 to be treated so that said workpiece assumes a characteristic coloration at to be treated. The image thus produced by the marker can be detected with the same optics that is used for coupling in the processing laser beam 50, and can be evaluated. In a next step, the photosensitizer can then be applied on the basis of this evaluation to the sites to be processed or to be ablated. As illustrated, the LEDs 73 can, for example, be arranged on a horizontal end section of the handpiece 70, and their spatial arrangement can be circular, for example, so that it is possible to attain an illumination that is as homogeneous and rotationally symmetrical as possible. The LEDs 73 are connected to electrical supply lines (not illustrated) that are guided inside the handpiece 70 and supply the LEDs 73 with electric power. The LEDs 73 can be single colored, that is to say quasi-monochromatic LEDs such as, for example, LEDs emitting red light. However, it would advantageously be possible to use white light LEDs since firstly, the workpiece is more effectively illuminated hereby, and secondly, under some circumstances, a larger selection of markers that can be excited with different wavelengths is thereby available. One or more white light LEDs and one red emitting laser diode can be used as pointers, for example.

It may be remarked that the embodiment illustrated in FIG. 4 of a laser beam aligning unit can be regarded as an independent invention. This laser beam aligning unit has a handpiece 70, a deflection unit 90 for deflecting a processing laser beam 50 and/or, if appropriate, a diagnostic laser beam, an attachment 250 for fixing the handpiece 70 on a surrounding area of the material to be processed, and at least one LED 73 for illuminating and/or for exciting a marker or photosensitizer. This independent invention can also be combined with any of the other embodiments described in this application, and/or be developed with any of the features described in this application. This also covers primary units such as a laser processing device that, as described above, includes a laser beam aligning unit.

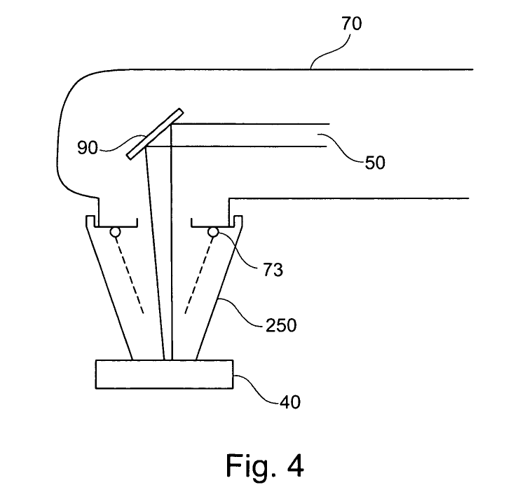

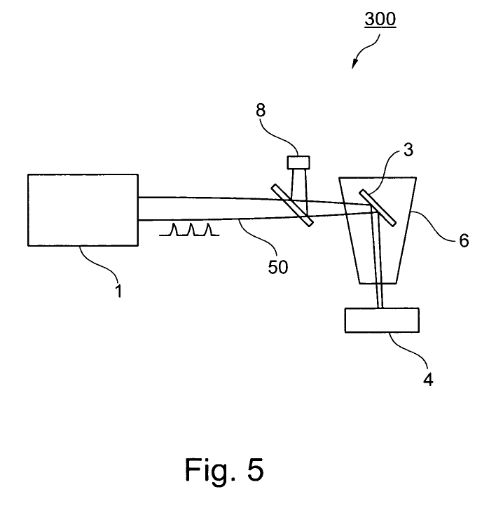

FIG. 5 is a schematic of a further general embodiment of a laser processing device as per the second aspect, which is not illustrated with dimensional ratios true to scale. The laser processing device 300 has a laser beam source 1, which emits a pulsed processing laser beam 50. The processing laser beam 50 is focused on a workpiece 4 to be processed. If appropriate, the processing laser beam 50 can be deflected beforehand by an optical deflection unit 3 such as a mirror, a mirror system composed of a plurality of mirrors, a scanning device or a deflection prism. The workpiece 4 can consist of any desired material, as mentioned in the introduction. It can in this case also be a tooth of a patient or another biological tissue. The laser processing device 300 furthermore has a UV detector 8, by means of which UV radiation can be detected that was produced by the processed workpiece 4 during the processing with the processing laser beam 50. The UV detector 8 can be coupled to an evaluation and control unit (not illustrated), which in turn is coupled to the laser beam source 1. The signal of the UV detector 8 is evaluated in the evaluation and control unit, and a decision is made as to whether and in what fashion the laser radiation emitted by the laser beam source 1 is modified.

In place of a single UV detector 8, use can also be made of a plurality of UV detectors, particularly if a plurality of different characteristics of the UV radiation are to be determined and this cannot readily be done using only one UV detector. Thus, for example, it is feasible to determine the radiation dose using a first UV detector, the spectral range or the wavelength using a second UV detector, and the dermatological UV index using a third UV detector. Individual UV detectors, or all of them, may also be embodied as quick or ultra-quick UV detectors, which more particularly have a response time in the picosecond range.

The laser processing device 300 can furthermore have a laser beam alignment unit 6 for aligning the laser beam 50 in the direction of a region to be processed of the workpiece 4. In the shown exemplary embodiment, the alignment unit 6 contains the deflection unit 3 and can moreover be embodied like the embodiments of alignment units shown in this application. More particularly, the alignment unit 6 can have a UV-reflecting coating on its inner wall. This coating can be used to route the UV radiation produced at the processed point efficiently in the direction of the UV detector 8. The coating can furthermore be designed such that it can serve as an absorber of free ions and/or electrons and/or radicals. The mirror 3 can likewise be coated such that it reflects the processing laser beam 50 but transmits the UV radiation to be measured. The detector 8 can then be situated behind the mirror 3.

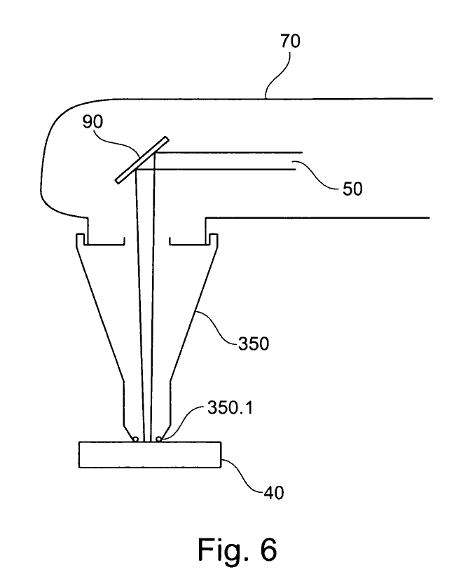

An aligning unit 70 in the form of a handpiece is represented in FIG. 6 in a cross section in order to illustrate a further exemplary embodiment. In this exemplary embodiment, the handpiece 70 is provided with an attachment 350 whose function consists not only in fixing the handpiece 70, but furthermore in encapsulating the surface region of the workpiece 40 to be treated, as is intended to be indicated, in a fashion that is merely symbolic and not necessarily technically realistic, by a seal 350.1 fitted on a lower edge section of the attachment 350. One goal of such an encapsulated fixing consists, in any case, in sealing off an immediate area surrounding the surface region of the workpiece 40 to be treated to the greatest possible extent, that is to say, in particular, an airtight and gastight fashion, from the surrounding area. An encapsulated fixing of this type renders it possible to optimize the processing, in particular in the case of a tooth treatment, in a most varied fashion, as is still to be discussed in the following exemplary embodiments. For example, it is possible to provide inside the handpiece 70 a suction device that can be used to suck off ablated material in a particularly efficient and reliable way owing to the outwardly sealing fixing. Moreover, a controlled atmosphere can be created around the processed surface region.

It may be remarked that the embodiment illustrated in FIG. 6 of a laser beam aligning unit can be regarded as an independent invention. This laser beam aligning unit has a handpiece 70, a deflection unit 90 for deflecting a processing laser beam 50 and/or, if appropriate, a diagnostic laser beam, an attachment 350 for fixing the handpiece 70 on a surrounding area of the workpiece to be processed, the attachment 350 being designed so that it can surround a surface region to be processed in a gastight fashion. This independent invention can also be combined with any of the other embodiments described in this application, and/or be developed with any of the features described in this application. This also covers primary units such as a laser processing device that, as described above, includes a laser beam aligning unit.

Reference is made to the fact that the embodiment of a laser beam alignment unit illustrated in FIG. 6 can be considered to be an independent invention. This laser beam alignment unit has a handpiece 70, a deflection unit 90 for deflecting a processing laser beam 50 and/or, optionally, a diagnostic laser beam, an attachment 350 for fixing the handpiece 70 to surroundings of the workpiece to be processed, wherein the attachment 350 is designed such that it can closely surround a surface region to be processed. This independent invention can also be combined with any other embodiment described in this application and/or can also be developed using any features described in this application. This also includes overarching units such as a laser processing device, which contains a laser beam alignment unit as described above.

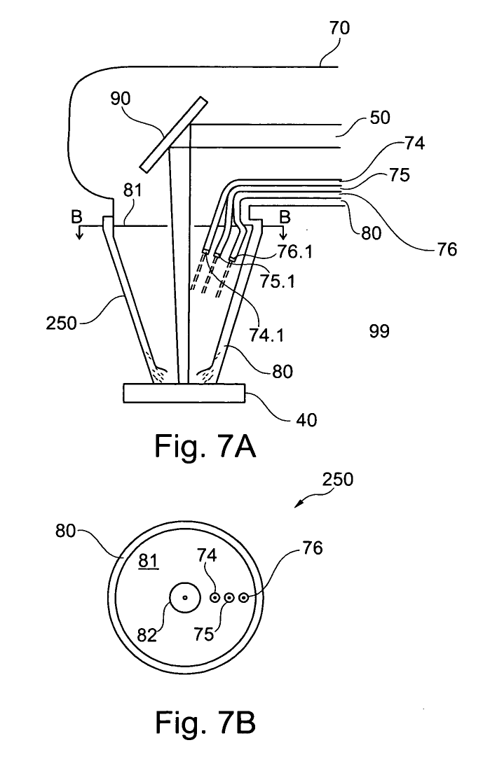

In FIGS. 7A and B, a further exemplary embodiment of an alignment unit 70 in the form of a handpiece is shown for illustrative purposes in a longitudinal section of FIG. 7A and in a cross section of 7B in a line B-B. In this embodiment, an attachment 250 has been placed onto the handpiece 70 and handpiece 70 and attachment 250 are embodied such that a suction channel 80 is held therein, as a result of which channel material that is ablated during the processing of the workpiece can be suctioned away in an efficient fashion. In the region of the attachment 250, the suction channel 80 is formed by virtue of the fact that the outer wall of the attachment 250 is embodied as a double wall, wherein the inner wall is open at the bottom and ablation products are suctioned into the intermediate space between the walls, which is self-contained over the whole circumference. At the upper end, this intermediate space is connected to a single line 80, which leads to the outside in the interior of the handpiece 70 and is connected to a suction system. The lower opening of the intermediate space is dilated in the direction of the region being processed, and so ablated material can be suctioned away in an efficient and directionally independent fashion. Provision can also be made for the inner wall to be perforated such that only individual narrow suction channels are formed in the intermediate space between the two walls, which narrow suction channels are then combined at the top to form an individual suction channel 80 that leads to the outside.

Particularly in the case of an application for dental treatments it is also possible to apply a thermal sensor at a suitable position (preferably in the lower region), which thermal sensor measures the surface temperature of the processed region. The sensor should emit a warning signal particularly if the temperature should exceed a value of 42.5° C. because this can indicate the onset of collagen fiber damage and the so-called “first pain”.

The handpiece 70 and the attachment 250 are furthermore embodied such that further feed lines are present, through which further substances can be routed in the direction of the workpiece 40 to be processed. At its upper end, the attachment 250 has an end plate 81, which contains a number of openings. A transparent safety glass 82 for the passage of the laser beam 50 is fixed in a central circular opening. The safety glass 82 is preferably transparent to UV such that the UV radiation produced by the processing can pass through it and can be detected by a UV detector as already described above. By way of example, the safety glass 82 may consist of synthetic diamond that was produced by means of a chemical vapor deposition (CVD) method. In this case the safety glass would also be transparent to the entire visible spectral range and to the infrared range, and so electromagnetic radiation from one of these spectral ranges can also be used as a measurement signal.

In the end plate 81 there are further openings for feed lines 74, 75, and 76. These feed lines 74, 75, and 76 are each connected to nozzles 74.1, 75.1, and 76.1 through which the corresponding substances can be supplied onto the workpiece. By way of example, a first feed line 74 lying on the inside can supply a photosensitizer and/or marker. A pigment can be supplied through a feed line situated further toward the outside. Such a pigment can be used as radiation protection against UV radiation and/or blue light. By way of example, a pigment such as melanin is distinguished as a suitable UV or blue light absorber. Finally, an outermost feed line can be used to supply a coolant such as air or water. The nozzles 74.1, 75.1, and 76.1 are preferably controllable, alignable, and focusable nozzles, by means of which the respective substances can be applied targeted in space and in a focused fashion. By way of example, they can be formed by spherical-head nozzles, which are known per se. The focusability allows the interaction between the laser beam, the photosensitizer, and the substrate always to take place in the focus only, i.e. precisely on the surface, and hence the laser beam does not react with only the sensitizer or only the air such that there can be an air breakdown in a worst-case scenario. The nozzles can furthermore be used to apply the aforementioned substances to the workpiece with variable output speeds, and so this can also supply an energy contribution in addition to the photon energy. More particularly, the geometry and arrangement of the various nozzles shown in FIGS. 7A, B allows and eases the provision of a controlled atmosphere within the fixing element.

It may be remarked again that all the features described in the illustrated embodiments and independent inventions can also be applied in the respective other described embodiments and independent inventions.

What is claimed is:

1. A method for ablating a material excluding tissue, mercury and amalgam fillings, the method comprising:
in a processing mode, providing a pulsed processing laser beam;
bringing a photosensitizer into an area surrounding a region of a material that is to be ablated; and
irradiating the region of the material that is to be ablated with the pulsed processing laser beam.

2. A method as claimed in claim 1, wherein
electromagnetic radiation emitted from surroundings of the ablated region is detected, and
the pulsed processing laser beam is set depending on the detected electromagnetic radiation.

3. A method as claimed in claim 1, wherein
the pulsed laser beam is set such that at least one of the following conditions is met:
the temperature of plasma generated by the processing laser beam is no more than 11604.5 K, which corresponds to 1 eV, the mean oscillation energy of the electrons in the alternating electromagnetic field of the processing laser beam is below 0.021 eV.

4. The method as claimed in claim 2, wherein
the pulsed processing laser beam is initially set on the basis of calculations such that at least one of the conditions is satisfied, and
the processing laser beam is set, during the running processing operation, depending on the detected electromagnetic radiation.

5. The method as claimed in claim 1, wherein
the photosensitizer and the wavelength of the laser beam are selected in such a way that the processing laser beam is absorbed at least partially in the photosensitizer by a single photon absorption, the absorption being in the vicinity of an absorption maximum of the photosensitizer.

6. The method as claimed in claim 1, wherein the photosensitizer and the wavelength of the laser beam are selected in such a way that the processing laser beam is absorbed at least partially in the photosensitizer by an N photon absorption, with N≧2, the absorption being in the vicinity of an absorption maximum of the photosensitizer.

7. The method as claimed in claim 1, wherein a repetition rate of the laser pulses is set in a range between 1 Hz and 10 MHz.

8. The method as claimed in claim 1, wherein the processing laser beam has a substantially rectangular beam profile.

9. The method as claimed in claim 1, wherein the region to be ablated is scanned by the processing laser beam.

10. The method as claimed in claim 9, wherein exactly one laser pulse is applied to a subregion covered by the focus of the processing laser beam.

11. The method as claimed in claim 10, wherein mutually adjacent sub regions covered by one laser pulse in each case have a spatial overlap with one another whose surface area is smaller than half the surface area of a subregion.

12. The method as claimed in claim 1, wherein control is carried out so that the spatial position of the focus remains on the surface of the region during ablating.

13. The method as claimed in claim 1, wherein the region to be ablated is determined in a diagnostic mode.

14. The method as claimed in claim 13, wherein the region to be ablated is determined by applying to the material a marker that, when in contact with a specific material type assumes a characteristic coloration or exhibits another detectable response, in particular on the basis of an external excitation.

15. The method as claimed in claim 14, wherein the marker is a photosensitizer and identical to the photosensitizer used in the processing mode.

16. The method as claimed in claim 13, wherein the region to be processed is determined by detecting the presence of a signal generated in the material or in a marker located in an area surrounding the material, and the signal strength of which is detected, if appropriate.

17. The method as claimed in claim 16, wherein the signal is a fluorescence radiation or a second or a higher harmonic of an electromagnetic radiation irradiated onto the material or the marker.

18. The method as claimed in claim 17, wherein the electromagnetic radiation is that of a diagnostic laser beam that has an energy density on the surface of the material or of the photosensitizer or marker which is smaller than the energy density that is required to process the material.

19. The method as claimed in claim 18, wherein the processing laser beam and the diagnostic laser beam are produced by one and the same laser radiation source.

20. The method as claimed in claim 17, wherein the electromagnetic radiation is that of an incoherent light source.

21. A laser ablation device for ablating a material, comprising:
a laser radiation source to provide a pulsed processing laser beam;
a laser beam aligning unit to decouple the laser beam in the direction of a region of the material to be ablated; and
an output device to output a photosensitizer in the direction of an area surrounding the region of the material that is to be ablated, the output device being connected to the laser beam aligning unit.

22. The laser ablation device as claimed in claim 21, comprising:
a detector to detect electromagnetic radiation emitted by an area surrounding the region that is to be ablated.

23. The laser ablation device as claimed in claim 21, wherein the laser pulses have a temporal full-width at half maximum in a range between 100 fs and 1 ns.

24. The laser ablation device as claimed in claim 21, wherein a repetition rate of the laser pulses can be set in a range between 1 Hz and 10 MHz.

25. The laser ablation device as claimed in claim 21, wherein the wavelength of the laser pulses and the material of the photosensitizer are selected in such a way that the processing laser beam is absorbed at least partially by a single photon absorption in the photosensitizer, the absorption being in the vicinity of an absorption maximum of the photosensitizer.

26. The laser ablation device as claimed in claim 21, wherein the wavelength of the laser pulses and the material of the photosensitizer are selected in such a way that the processing laser beam is absorbed at least partially in the photosensitizer by an N photon absorption, with N≧2, the absorption being in the vicinity of an absorption maximum of the photosensitizer.

27. The laser ablation device as claimed in claim 21, further comprising:
a fixer connected to the laser beam aligning unit to spatially fix a distal end of the laser beam aligning unit with reference to a section of the material to be ablated.

28. The laser ablation device as claimed in claim 21, further comprising:
a beam shaping unit to shape a substantially rectangular beam profile of the pulsed processing laser beam.

29. The laser ablation device as claimed in claim 21, further comprising:
a scanning unit to scan a region of the tissue with the processing laser beam.

30. The laser ablation device as claimed in claim 29, wherein the scanning unit is designed in such a way that exactly one laser pulse is applied to a subregion covered by the focus of the processing laser beam.

31. The laser ablation device as claimed in claim 29, wherein the scanning unit is designed in such a way that mutually adjacent sub regions covered by one laser pulse in each case have a spatial overlap with one another whose surface area is smaller than half a subregion.

32. The laser ablation device as claimed in claim 31, further comprising:
an autofocus unit to keep constant the spatial position of the focus on the surface of the tissue.

33. The laser ablation device as claimed in claim 31, further comprising:
a detection unit to detect the presence of a signal generated in the tissue or in an area surrounding it, and the strength of said signal, if appropriate.

34. The laser ablation device as claimed in claim 33, wherein the detection unit has an optical sensor.

35. The laser ablation device as claimed in claim 34, wherein the optical sensor is designed to detect a fluorescence radiation or a second harmonic or a higher harmonic of an electromagnetic radiation irradiated onto the tissue or the marker or the photosensitizer.

36. The laser ablation device as claimed in claim 21, wherein the laser beam aligning unit is designed as a handpiece wherein, in conjunction with the method of claim 20, the output device to output the photosensitizer is included at least in part.

37. The laser ablation device as claimed in claim 36, wherein the scanning unit and/or the autofocus unit are/is included in the handpiece.

38. The laser ablation device as claimed in claim 21, wherein the laser radiation source includes a laser oscillator, and the laser pulses generated by the laser oscillator can be fed to the aligning unit without further optical amplification.

39. The laser ablation device as claimed in claims 21, further comprising:
a plurality of nozzles which are or can be aligned in the direction of the region to be processed of the material or in the direction of another region.

40. The laser ablation device as claimed in claim 39, further comprising:
a photosensitizer nozzle to apply a photosensitizer onto the region to be processed, and optionally
a radiation protection nozzle to apply a radiation protection medium, onto a region outside of the region to be processed, and optionally
a coolant nozzle to apply a coolant onto the region to be processed and/or a region outside of the region to be processed.
